(19) United States
(12) Patent Application Publication
(10) Pub. No.: US 2018/0195317 A1
(43) Pub. Date: Jul. 12, 2018

(54) DOOR CLOSING APPARATUS WITH CAMERA

(71) Applicant: AISIN TECHNICAL CENTER OF AMERICA, INC., Northville, MI (US)

(72) Inventor: Emiko OKUMA, Novi, MI (US)

(73) Assignee: AISIN TECHNICAL CENTER OF AMERICA, INC., Northville, MI (US)

(21) Appl. No.: 15/401,736

(22) Filed: Jan. 9, 2017

(51) Int. Cl. E05B 79/08; B60R 11/04; B60J 5/10; E05F 15/40; E05B 77/14; E05B 83/18; G03B 17/56; H04N 7/18; H04N 5/232; F16M 13/02

(52) U.S. Cl. CPC E05B 79/08; B60R 11/04; B60J 5/105; E05F 15/40; E05B 77/14; B60R 2011/0021; G03B 17/561; H04N 7/183; H04N 5/23296; F16M 13/02; E05B 83/18

(57) ABSTRACT

A door closing apparatus including a camera with at least four pins, a first arm including a first open slot and a first arc slot, the first open slot rotatably supporting a first pin of the at least four pins of the camera and the first arc slot rotatably supporting a second pin of the at least four pins of the camera, and a second arm including a second open slot and a second arc slot, the second open slot rotatably supporting a third pin of the at least four pins of the camera and the second arc slot rotatably supporting a fourth pin of the at least four pins of the camera. The first arm and the second arm are configured to rotate about a first axis allowing the camera to rotate about the first axis as well as about a second axis of the at least four pins.

### BACKGROUND

### Field of the Disclosure

This disclosure relates generally to improvements to a door closing apparatus. More particularly the present disclosure relates to improvements relating to a door fitted with a camera that operates to detect objects including human motions.

### Description of the Related Art

It is commonly observed that an object obstructs a door from closing or the object gets stuck between the door and a door frame. Particularly, when loading objects in the back of a vehicle, the objects may be in the path of the door and obstruct the door while closing. As such, door closing mechanisms or apparatus are provided to detect objects and to prevent the door from closing in presence of any objects.

In a conventional door closing apparatus, a camera can be enclosed in an emblem of the door such that the camera can project out from an emblem (when the vehicle is in parking or reverse mode) and stored back inside the emblem (when the vehicle is in driving mode). The back and forth motion of the camera is enabled by mounting the camera on a rotating mount operated by a motor. The camera can project out of the emblem (a housing) with sealed cover and be stored back inside by means of a motor. Further, an orientation of the camera can be optimized to obtain a wider view when the emblem door is opened. However, the conventional mechanisms allow the camera to capture only one view (e.g., a rear view) of the vehicle with the help of a motor that controls the camera position and orientation as well as the opening and closing of the emblem.

A door closing apparatus that can capture multiple views, particularly between the door and the door frame when the door is open, is desirable. Also, a non-motorized apparatus is desired to save battery power used to operate the motor and to make the vehicle energy efficient and cost effective while achieving a fast camera orientation.

### SUMMARY

According to an embodiment of the present disclosure, there is provided door closing apparatus. The door closing apparatus includes a camera with at least four pins, a first arm including a first open slot and a first arc slot, the first open slot rotatably supporting a first pin of the at least four pins of the camera and the first arc slot rotatably supporting a second pin of the at least four pins of the camera, and a second arm including a second open slot and a second arc slot, the second open slot rotatably supporting a third pin of the at least four pins of the camera and the second arc slot rotatably supporting a fourth pin of the at least four pins of the camera. The first arm and the second arm are configured to rotate about a first axis allowing the camera to rotate about the first axis as well as about a second axis of the at least four pins.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 illustrates a backdoor of a vehicle with a camera according to an exemplary embodiment of the present disclosure;

FIG. 2A illustrates the camera occupying a first orientation when the backdoor is closed and latched by the door closing apparatus according to an exemplary embodiment of the present disclosure;

FIG. 2B illustrates the camera occupying a second orientation when the door closing apparatus is unlatched and the backdoor is slightly opened according to an exemplary embodiment;

FIG. 3 is an exploded view of a door closing apparatus with the camera according to an exemplary embodiment of the present disclosure;

FIG. 4A illustrates a first arm of the door closing apparatus of FIG. 3 according to an exemplary embodiment of the present disclosure;

FIG. 4B illustrates a worm gear of the door closing apparatus of FIG. 3 according to an exemplary embodiment of the present disclosure;

FIG. 4C illustrates an assembly of the worm gear and the first arm and a second arm of the door closing apparatus of FIG. 3 according to an exemplary embodiment of the present disclosure;

FIGS. 5A, 5B and 5C illustrates a first orientation, an intermediate orientation and a second orientation of the camera according to an exemplary embodiment of the present disclosure;

FIGS. 6A and 6C are front views of a latch, gear and camera subassembly of the door closing apparatus in full latched and half latched conditions, respectively, with the camera in the first orientation according to an exemplary embodiment of the present disclosure;

FIG. 6B is a side view of FIG. 6A and FIG. 6C illustrating the camera in the first orientation according to an exemplary embodiment of the present disclosure;

FIG. 7A is a front view of a latch, gear and camera subassembly of the door closing apparatus in unlatched condition with the camera in the second orientation according to an exemplary embodiment of the present disclosure;

FIG. 7B is a side view of FIG. 7A illustrating the camera in the second orientation according to an exemplary embodiment of the present disclosure;

FIG. 8 is a cross-section view of the door closing apparatus according to an exemplary embodiment of the present disclosure.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) may be practiced without those specific details. In some instances, well-known structures and components may be shown in block diagram form in order to avoid obscuring the concepts of the disclosed subject matter.

It is to be understood that terms such as “left,” “right,” “bottom,” “front,” “rear,” “side,” “length,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” and similar terms generally refer to ranges that include the identified value within a margin of 20% or preferably 5% in certain embodiments, and any values therebetween.

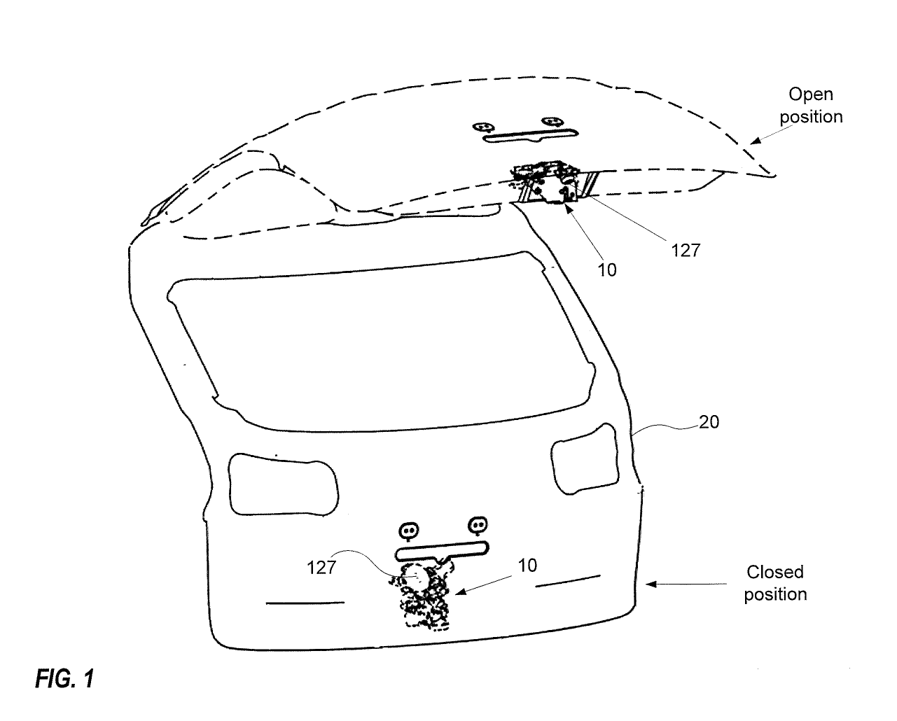

FIG. 1 illustrates a backdoor 20 of a vehicle with a camera 127 according to an exemplary embodiment of the present disclosure. The backdoor 20 of the vehicle includes a door closing apparatus 10 installed inside the backdoor 20 at a bottom end of the backdoor 20. The backdoor 20 can be in a closed position and latched to the vehicle by the door closing apparatus 10 and the striker 200 fixed on the vehicle floor 30. While the backdoor 20 is unlatched from the door closing apparatus 10, and it can be raised to an open position allowing access to a back compartment (not illustrated) of the vehicle. A camera 127 of the door closing apparatus 10 rotates downward in a continuous motion as the backdoor 20 moves from the closed position to the open position.

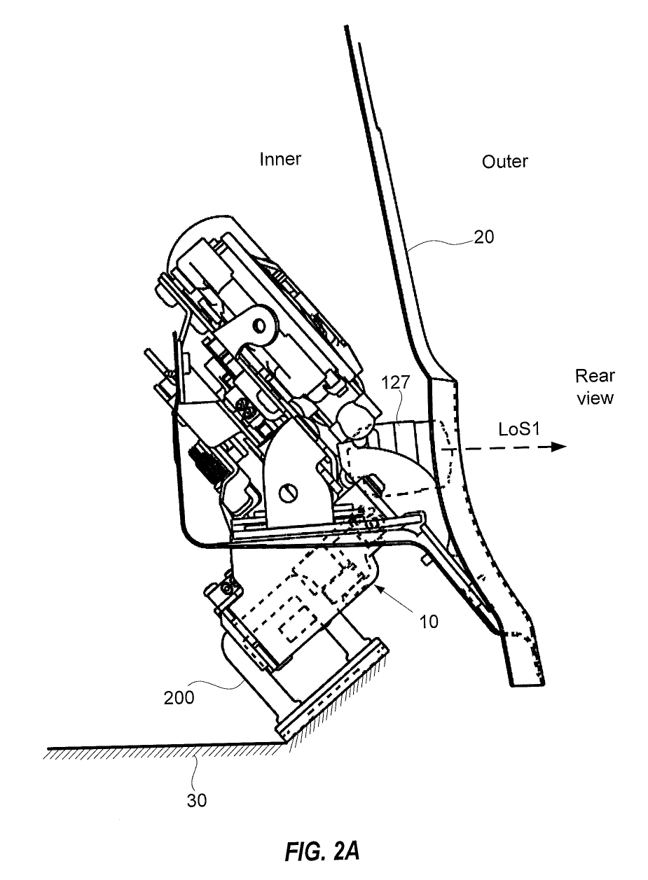

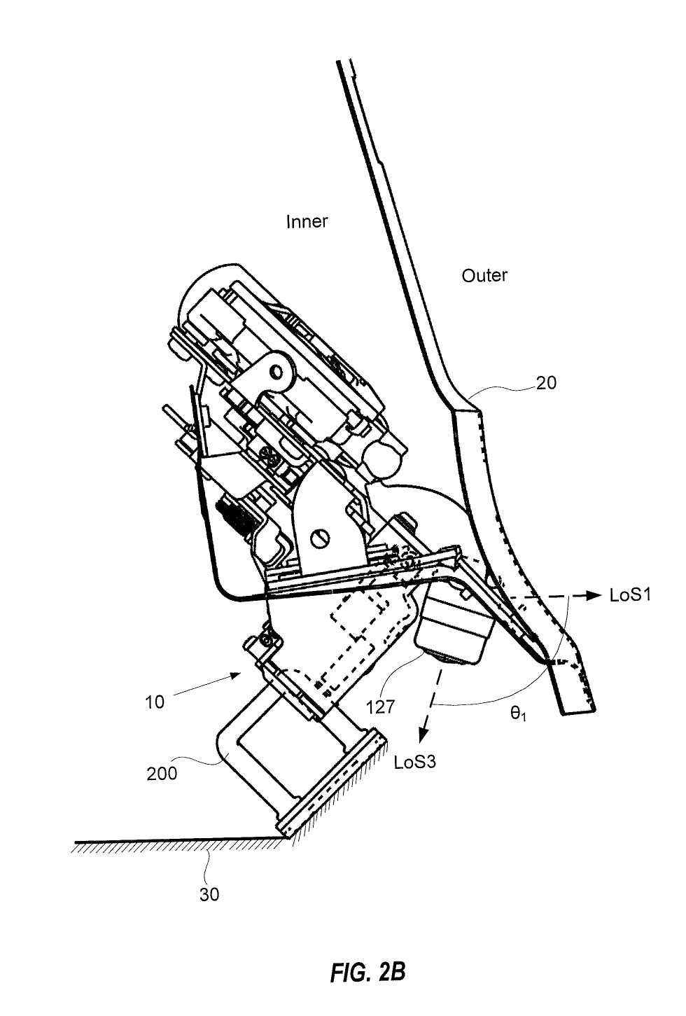

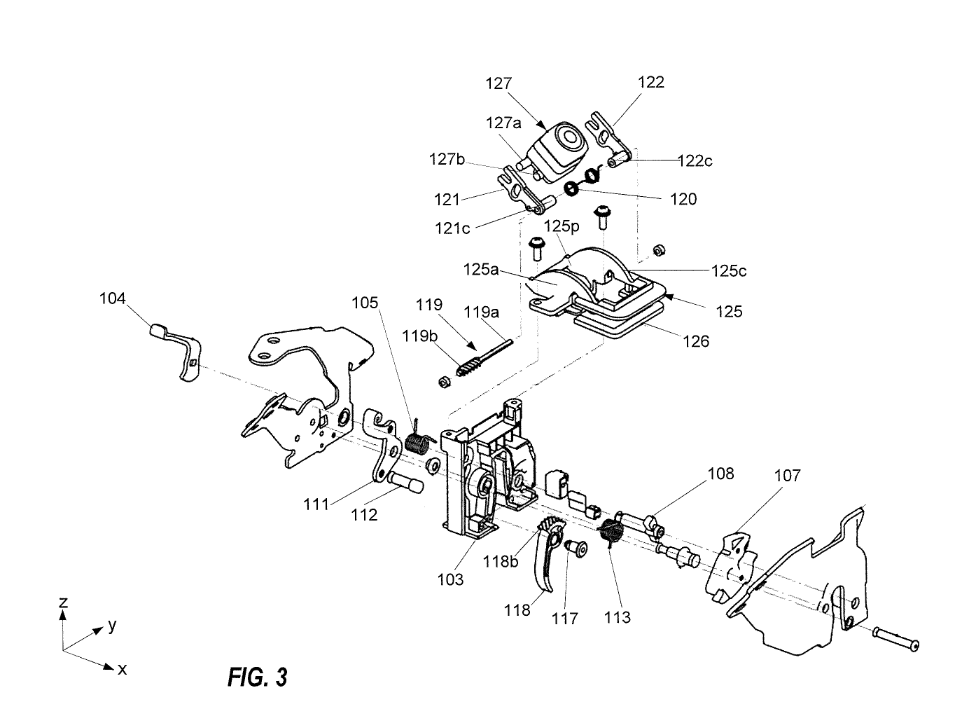

The door closing apparatus 10 is a complex mechanism operated mechanically to move the camera 127 such that the camera 127 captures a rear view (or a first view) of the vehicle when the backdoor 20 is closed and a second view between the backdoor 20 and vehicle when the backdoor 20 is opened. As such, the door closing apparatus 10 can detect via the camera 127 objects between the backdoor 20 and also capture the rear view of the vehicle. As opposed to conventional applications, the door closing apparatus 10 does not include a motor to move the camera 127. The components of the door closing apparatus 10 are illustrated in FIG. 3 and the operation is explained in detail with respect to FIGS. 2A-2B, 5A-5C, 6A-6C, and 7A-7B.

FIG. 2A illustrates the camera 127 in a first orientation according to an exemplary embodiment of the present disclosure. In the first orientation, the camera 127 of the door closing apparatus 10 is oriented such that a line of sight LoS1 of the camera 127 is substantially horizontal and points to the rear of the vehicle to capture the rear view of the vehicle when the backdoor 20 is latched and closed.

Referring to FIG. 2B, when the door closing apparatus 10 is unlatched and the back door 20 is opened, the camera 127 rotates downward by an angle θ₁ with respect to the line of sight LoS1 to occupy a second orientation. In the second orientation, the line of sight LoS3 points to a space between the backdoor 20 and the floor 30 of the vehicle, thus capturing objects present between the backdoor 20 and the floor 30 of the vehicle.

The door closing apparatus 10 can be operated to latch and unlatch manually or automatically to be engaged and disengaged with the striker 200 (in FIG. 2A and FIG. 2B). When the backdoor 20 is closing and the door closing apparatus 10 is operated to latch (in FIG. 2A), the camera 127 occupies the first orientation. When the door closing apparatus 10 is operated to unlatch (in FIG. 2B), the back door 20 can be opened and the camera 127 occupies the second orientation.

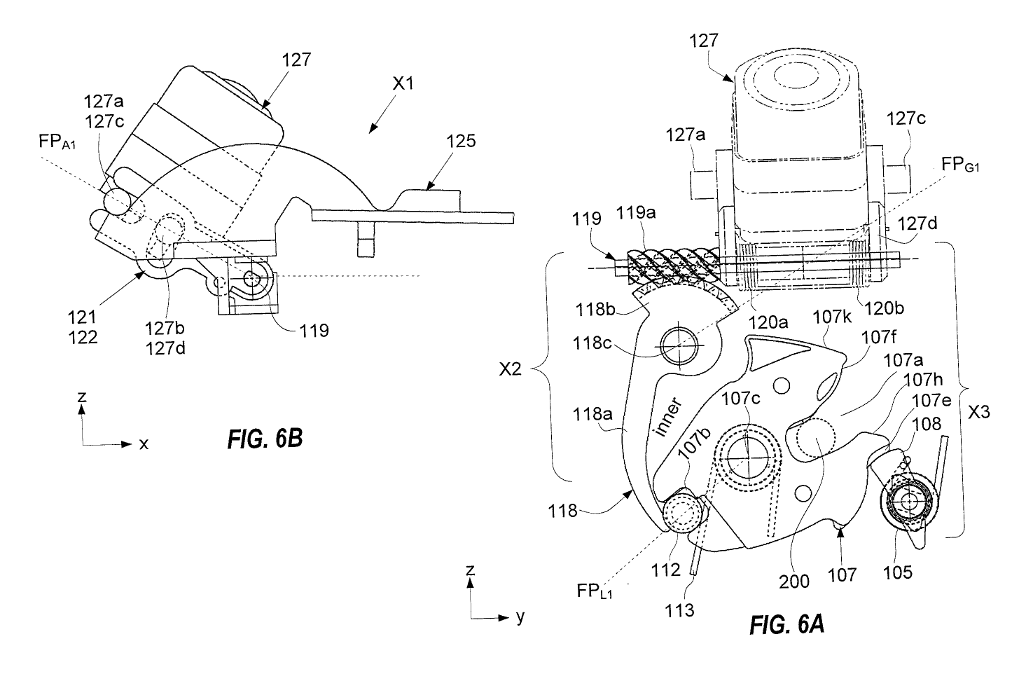

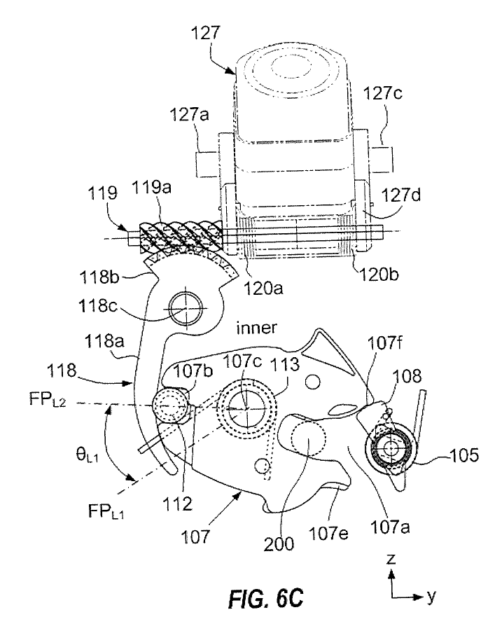

FIG. 3 is an exploded view of the door closing apparatus 10 according to an exemplary embodiment of the present disclosure. The door closing apparatus 10 comprises different subassemblies including a camera subassembly X1 (in FIG. 6B), a camera and gear subassembly X2 (illustrated in FIG. 6A), and a latch and gear subassembly X3 (illustrated in FIG. 6A). The camera subassembly X1 allows the camera 127 to rotate from the first orientation to the second orientation and vice-versa, as discussed in FIGS. 2A and 2B. The camera and gear subassembly X2 includes a gear set that drives the camera subassembly X1. The latch and gear subassembly X3 includes a latch 107 that controls the movement of the gear set of the camera and gear subassembly X2.

The camera subassembly X1 includes the camera 127, a first arm 121, a second arm 122 and a camera bracket 125. Further, the camera subassembly X1 can include torsional spring 120 connected to the arms 121 and 122, and a bracket seal 126 connected to the camera bracket 125.

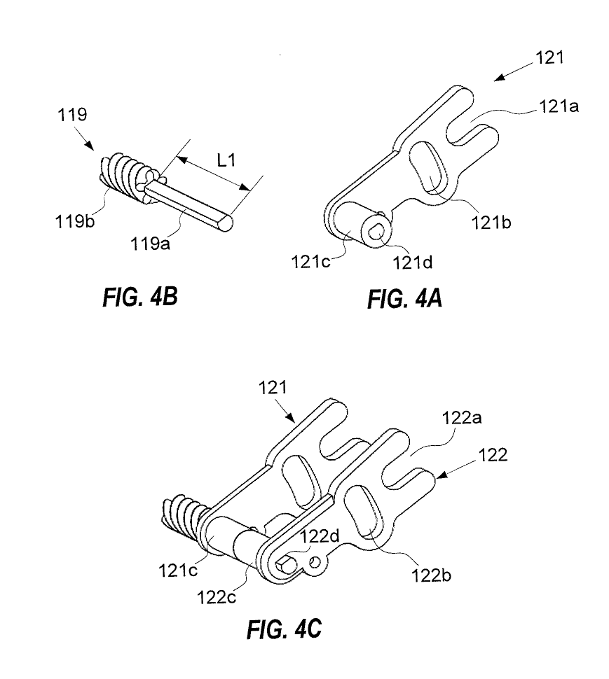

Referring to FIGS. 3 and 4A, the first arm 121 includes an open slot 121a, an arc slot 121b and a hollow shaft 121c. The open slot 121a is formed along the length (or a radial axis) at a first end of the first arm 121. The open slot 121a has an open end, as shown. The arc slot 121b is formed between the first end and a second end and is substantially perpendicular to the length. The arc slot 121b has closed ends. The hollow shaft 121c can be integrally attached at the second end of the first arm 121 in a perpendicular manner (along a y-axis). The hollow shaft 121c provides a pivot point for the first arm 121. The second arm 122 is similar in construction to the first arm 121 and includes an open slot 122a and an arc slot 122b, and a shaft 122c (illustrated in FIG. 4C).

The torsional spring 120 can be installed to the shafts 121c and 122c. The torsional spring 120 can compress and decompress as the first arm 121 and the second arm 122 rotate about the shafts 121c and 122c. The torsional spring 120 can provide a return force to move the first arm 121 and the second arm 122 to an initial position (or a second position of the arms 121 and 122). The torsional spring 120 can be pre-tensioned and maintain the camera 127 in the first orientation, when the backdoor 20 is closed.

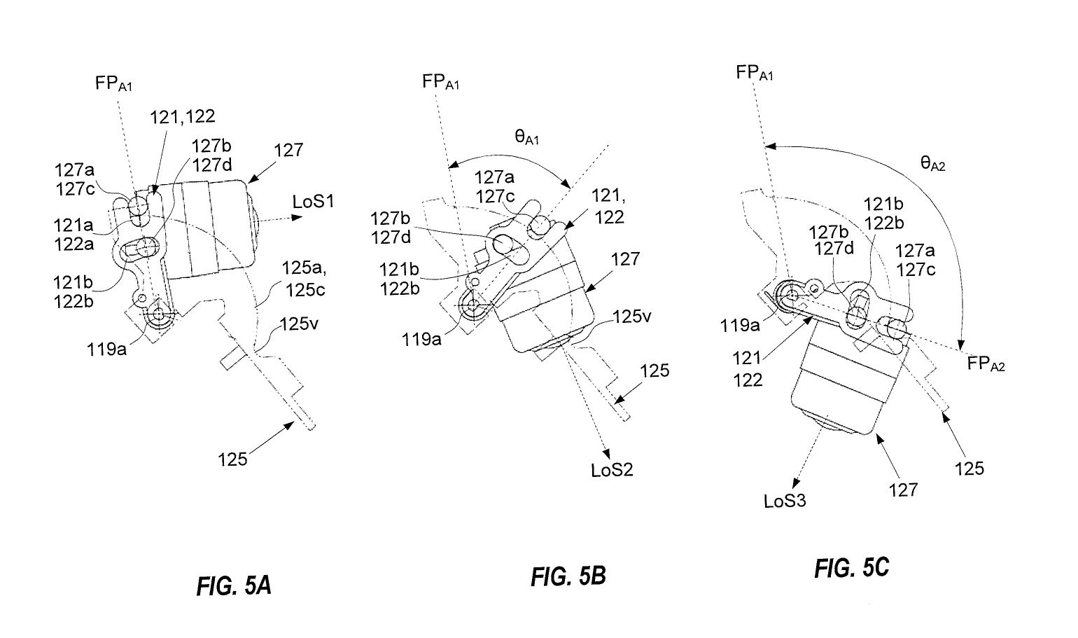

The camera 127 includes four pins 127a, 127b, 127c (illustrated in FIGS. 6A and 6B), and 127d (illustrated in FIGS. 6A and 6B) along the periphery of the camera 127. The four pins are rotatably connected in the open slots 121a and 122a, and the arc slots 121b and 122b. For example, a first pin 127a is inserted in the open slot 121a and a second pin 127b is inserted in the arc slot 121b of the first arm 121. Similarly, a third pin 127c (not illustrated) and a fourth pin 127d (not illustrated) can be connected to the second arm 122. The pins 127a-127d allow rotation of the camera about the y-axis. The relative motion between the camera 127 and the first arm 121 (and the second arm 122) is discussed with respect to FIGS. 5A-5C.

Referring back to FIG. 3, the subassembly of the camera 127, the first arm 121, the second arm 122, and the torsional spring 120 can be placed in a pocket 125p of the camera bracket 125. The camera bracket 125 also includes two profiled walls 125a and 125c that provides support for the first arm 121 and the second arm 122. The profiled walls 125a and 125c are profiled shape with a curved edge that guides the pins 127a and 127c. The profiled walls 125a and 125c allows a relative motion between the camera 127 and the arms 121 and 122, as discussed with respect to FIGS. 5A-5C, 6B, and 7B. The relative motion refers to movement (sliding and/or rotation) of the camera 127 with respect to the arms 121 and 122.

Referring to FIG. 3, the door closing apparatus 10 includes a gear lever 118 and a worm gear 119. The worm gear 119 includes a shaft portion 119a and a worm portion 119b. The shaft portion 119a is connected to the first arm 121 and to the second arm 122. The worm portion 119b is connected to a gear portion 118b of the gear lever 118 to form the subassembly X2. The worm gear 119 is connected to the gear lever 118 such that the worm gear 119 rotates about a y-axis and the gear lever 118 rotates about an x-axis. The connection and the operation in the camera and gear sub assembly X2 are further discussed with respect to FIGS. 6A-6C, 7A-7B and FIG. 8.

Referring to FIG. 3, the door closing apparatus 10 further includes the latch 107, a latch lever 111, a latch pin 112, a latch spring 113, a pawl 108, and a pawl spring 105 that can be assembled to form a latch subassembly. The latch subassembly can be further assembled with the subassembly X2 to form the latch and gear subassembly X3 (refer FIG. 6A).

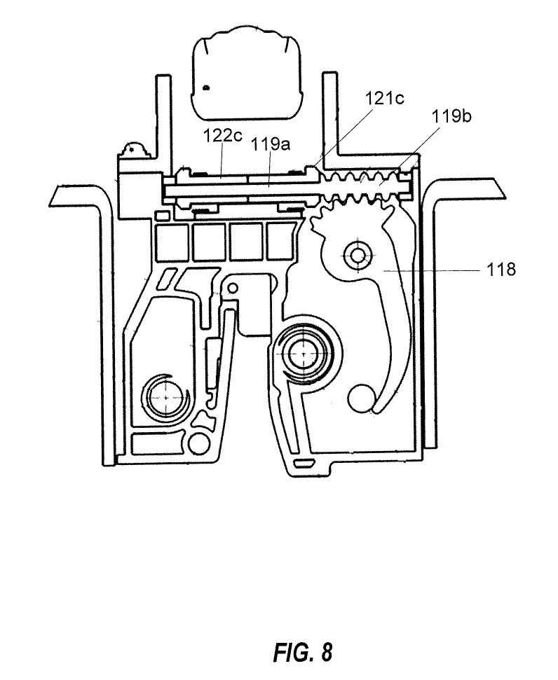

FIGS. 6A and 6C are front views of the subassemblies X2 and X3, when the door closing apparatus 10 is in full latched and half latched state, respectively. FIG. 8A is a front view of the subassemblies X2 and X3, when the door closing apparatus 10 is in unlatched state.

The latch 107 has an irregular profiled shape that includes a striker slot 107a (on the right side), and a pin slot 107b (on the left side). The latch pin 112 (referred as pin 112 hereinafter) is inserted in the pin slot 107b at one end (right), and clinched to the latch lever 111 at the opposite end (left) so that the pin 112 can rotate together with the latch lever 111 and the latch 107.

The latch 107 is contacted to a pawl 108 at an end 107e at full latched condition, the end 107f at half latched condition, and the end 107g at unlatched condition. The latch 107 is also contacted to the gear lever 118 at an end on the left side via the pin 112. The end 107e is a point along the circumference of the latch 107 located on the right side of the latch 107 below the striker slot 107a of the latch 107.

The latch spring 113 (in a compressed state) is connected at a center 107c of the latch 107. The latch spring 113 is a torsional spring with one end connected to the pin 112. The latch spring 113 compresses and decompresses as the latch 107 rotates about a center 107c.

For latching operation, the latch 107 is rotated in counter clockwise direction by the striker 200 moving into the striker slot 107a in z direction as the backdoor is closing. During this rotation of the latch 107, the circumference 107h or 107k of the latch 107 pushes the pawl 108 to rotate in clockwise direction causing the reaction force from the pawl spring 105. When the end 107f and the end 107e of the latch 107 passes by an outer circumference surface of the pawl 108, the pawl 108 rotates back in counter clockwise direction due to the force of the pawl spring 105. The pawl 108 then blocks the clockwise rotation of the latch 107 that may be caused by a spring force exerted by the latch spring 113, so that the door closing apparatus are kept engaged with the striker 200.

For the unlatching operation, the pawl 108 is rotated clockwise by the lift lever 104 until the circumference of the pawl 108 is out from the moving area of the latch ends 107e and 107f to unblock the clockwise rotation of the latch 107. The door closer apparatus 10 can be disengaged from the striker as the backdoor is moved to open while the pawl is unblocking the clockwise rotation of the latch 107. After the striker comes out from the door closing apparatus 10, the pawl 108 rotates and returns to the position as shown in FIG. 8A.

FIG. 4A illustrates the first arm 121 of the door closing apparatus 10 of FIG. 3 according to an exemplary embodiment of the present disclosure. As discussed earlier in the present disclosure, the first arm 121 (and the second arm 122) includes the open slot 121a (122a), the arc slot 121b (122b) and the shaft 121c (122c). The shaft 121c (122c) has a through hole 121d (122d). The through hole 121d (and 122d) receives the shaft portion 119a of the worm gear 119 and produces relative rotation motion of the arm 121 and 122 with respect to the worm gear 119. For example, the through hole 121d (and 122d) can be a D-shaped hole extending throughout the length of the shaft 121c (and 122c). The second arm 122 has a similar construction as the first arm 121.

Referring to FIG. 4B, the shaft portion 119a of the worm gear 119 can have a D-shaped cross-section similar to the through hole 121d of the shaft 121c of the first arm 121. Referring to FIG. 4C, the first arm 121 and the second arm 122 can be connected by inserting the shaft portion 119a of the worm gear 119 in the through holes 121d and 122d. The shafts 121c and 122c are oriented toward each other and move simultaneously as the worm 119 rotates. The connection between the arms 121 and 122 and the worm gear 119 is further illustrates in a cross-section view of the door closing apparatus 10 of FIG. 9. FIG. 9 shows that the shaft portion 119a of the worm gear 119 is co-axially connected to the shafts 121c and 122c of the first arm 121 and the second arm 122, respectively. The worm portion 119b is connected to the gear lever 118, which rotates the worm gear 119. The rotation of the worm gear 119 can be transmitted to the first arm 121 and the second arm 122, further illustrated in FIGS. 5A, 5B, and 5C.

FIGS. 5A, 5B and 5C illustrate the first orientation, the intermediate orientation and the second orientation of the camera 127 according to an exemplary embodiment of the present disclosure. The camera 127 can rotate about two axes—a first axis and a second axis. The first axis refers to an axis of rotation provided by the shaft portion 119a of the worm gear 119. The second axis refers to an axis of rotation about the four pins 127a, 127b, 127c, and 127d. The first axis and the second axis are parallel to the y-axis.

The camera 127 can rotate relative to the first arm 121 (and the second arm 122) about the first pin 127a (and the third pin 127c) located in the open slot 121a (and 122c). The first pin 127a (and the third pin 127c) slides along the open slot 121a (and 122c), as the second pin 127b (and the fourth pin 127d) located in the arc slot 121b (and 122b) constraints vertical movement of the camera 127. On the other hand, the second pin 127b (and the fourth pin 127d) can slide along the arc slot 121b (and 122b) as the first arm 121 (and the second arm 122) rotates about the shaft portion 119a of the worm gear 119.

The first pin 127a (and the third pin 127c) also slides along the profiled walls 125a and 125c of the camera bracket 125. For example, in the first position FP_{A1} of the arms 121 and 122 (i.e., corresponding to a half latch or full latch position of the door closing apparatus 10), the pins 127a and 127c are located on the left end of the profiled walls 125a and 125c and the camera 127 has the line of sight LoS1 pointing to the rear of the vehicle.

As the door closing apparatus 10 occupies an intermediate position between latched and unlatched states, the camera 127 rotates about the first axis and the second axis to occupy the intermediate orientation (in FIG. 5B). As the door closing apparatus 10 is unlatched and the backdoor 20 (not illustrates) opens further to a fully open position, the camera 127 rotates to occupy the second orientation (in FIG. 5C).

Referring to FIG. 5B, as the arms 121 and 122 rotate in clockwise direction by an angle θ_{A1} with respect to the first position FP_{A1}, the second pin 127b (and the fourth pin 127d) slides back along the arc slot 121b (and 122b) and the camera 127 rotates with the line of sight LoS2 pointing downward. The rotation of camera 127 in clockwise direction is a combined effect of a clockwise rotation of the arms 121 and 122 by decompressing force of spring 120 and a rotation about the pins 127a-127d caused by the gravitational effect due camera's own weight. The clockwise rotation of the arms 121 and 122 eventually transmits the force to the gear lever via the gear 119.

The camera 127 starts moving in a clockwise direction, due to the force exerted by the pins 127a and 127c, and simultaneously starts rotating about the second axis. The clockwise rotation of the arms 121 and 122 and the rotation of the camera 127 causes the pin 127b and 127d to move backward in the arc slots 121b and 122b creating an offset between the pins 127a and 127c, and pins 127b and 127d. Furthermore, the length of the arc slots 121b and 122b control excess sliding and tilting of the camera 127 to make the camera 127 move within inside of the backdoor 20.

Referring to FIG. 5C, as the door closing apparatus 10 is unlatched, the camera 127 rotates further to occupy the second orientation, where the line of sight LoS3 points toward the floor of the vehicle. To occupy the second orientation, the arms 121 and 122 rotate by an angle θ_{A2} with respect to the first position FP_{A1}. The first pin 127a (and the third pin 127c) reaches an end of the profiled wall 125a (and 125c) and sits in a valley 125v, which prevents the pins 127a and 127c from moving further along the profiled walls 125a and 125c.

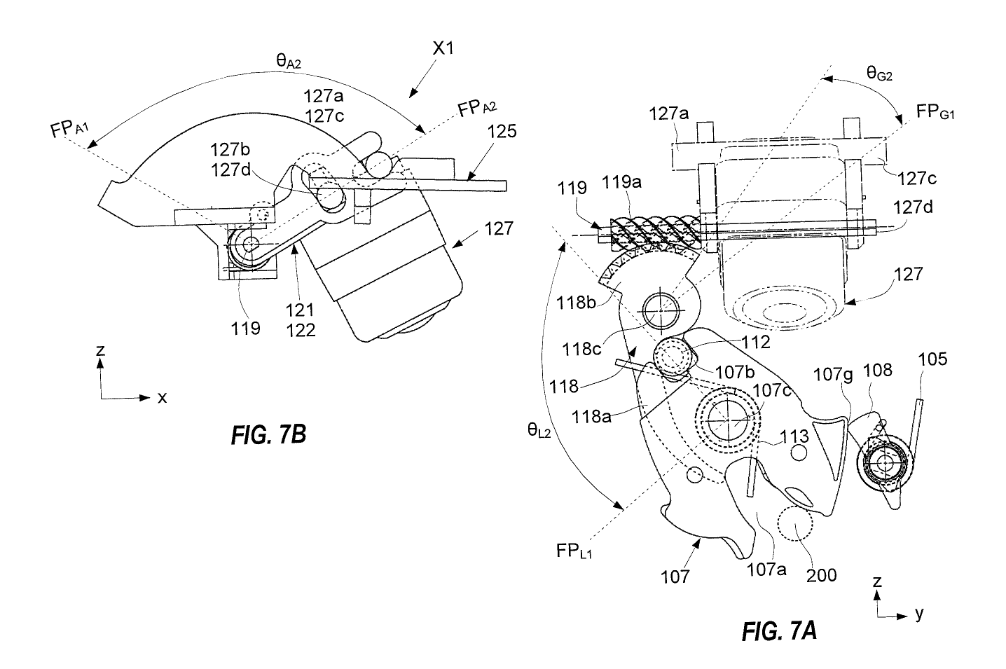

The arms 121 and 122 receive rotation input from the shaft portion 119a of the worm 119, which itself receives a rotational input from the gear lever 118, when the door closing apparatus 10 is latched from the unlatched state. As the backdoor 20 is closed and the door closing apparatus is latched, the components of the subassemblies X2 and X3 convert and transmit the latching action of the door closing apparatus 10 into rotational input to the shaft portion 119a, which in turn causes the camera 127 to rotate. The transmission of motion between components of the subassemblies X2 and X3 is further discussed with respect to FIGS. 6A-6C, and 7A-7B.

The gear lever 118 includes a handle portion 118a and the gear portion 118b. The gear lever 118 is hinged at a lever hinge point 118c between the gear portion 118b and the handle portion 118a allowing the lever 118 to rotate about a third axis (i.e., parallel to the x-axis). The handle portion 118a has an elongated curved shape extending below the lever hinge point 118c. The gear portion 118b is located above the lever hinge point 118c, which is a proximal end of the gear lever 118. A distal end of the gear lever 118, particularly of the handle portion 118a, is contacted to the pin 112 on an inner side (right side) of the handle portion 118a.

FIG. 6B is a side view of subassembly X1 illustrating the first orientation of the camera 127, similar to FIG. 5A. When the latch 107 is in full and half latched condition as shown in FIGS. 6A and 6C, the pin 112 is in the area between FP_{L1} and FP_{L2} (refer FIG. 6C). The inner profile of the handle portion 118a of the gear lever 118 is cylindrical with a latch axis 107c and tangent to outer surface of the pin 112, so that the camera 127 stays in the first orientation (i.e., pointing to the rear of the vehicle) as in FIG. 6B.

The pin 112 can slide on the curved shape along length of the handle portion 118a of the gear lever 118. The sliding of the pin 112 from the proximal end to the distal end of the gear lever 118 dominates the gear lever 118 to rotate about the lever hinge point 118c.

When the door closing apparatus 10 is changed from latched state (FIGS. 6A and 6C) to unlatched state (FIG. 7A), the pin 112 and the latch 107 rotate clockwise by an angle θ_{L2} with respect to the first position FP_{L1}. The pin moves to the proximal end of the handle portion 118a of the gear lever 118 and the handle portion 118a of the gear lever 118 no longer receives the force from the pin 112. Accordingly the gear 118 rotates in counter clockwise direction by an angle θ_{G2} as shown in FIG. 7A by the transmission of decompressing force of spring 120 and a rotation about the pins 127a-127d caused by the gravitational effect due camera's own weight via the worm gear with the arms 121 and 122.

On the other hand, when the door closing apparatus 10 is changed from unlatched state (FIG. 7A) to latched state (FIGS. 6A and 6C), the pin 112 pushes the handle portion 118a of the gear lever 118 towards the left causing the gear lever 118 to rotate clockwise about the lever hinge point 118c. Referring to FIGS. 6B and 7B, the clockwise rotation of the gear lever 118 causes the worm gear 119 to rotate the arm 121 and 122 in a counter clockwise direction. The arms 121 and 122 make an angle θ_{A2} with respect to the second position FP_{A2} of the arms 121 and 122. Also, the rotation of the arms 121 and 122 causes the camera 127 to rotate to the first orientation through the intermediate orientation, as discussed earlier with respect to FIGS. 5A, 5B, and 5C.

The door closing apparatus 10 can have several applications. For example, when the installed in a backdoor of a vehicle, the camera 127 can capture objects between the door and a floor of the vehicle and send an object presence signal to a processing circuit of the vehicle indicating presence of an object and/or to prevent the door from closing. The processing circuit can be configured to receive the signal from the camera and activate, for example, a flashing light or a sound signal to alert the user. Alternatively or in addition, the processing circuitry can be configured to prevent the door from closing.

The door closing apparatus 10 can be used in other application where an upward and downward opening and closing action is performed. For example, in aircrafts, furnace doors in manufacturing industry, solution mixing chambers in chemical industry, washing machines or dryers, etc.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A door closing apparatus, comprising:
a camera with at least four pins;
a first arm including a first open slot and a first arc slot, the first open slot rotatably supporting a first pin of the at least four pins of the camera and the first arc slot rotatably supporting a second pin of the at least four pins of the camera; and
a second arm including a second open slot and a second arc slot, the second open slot rotatably supporting a third pin of the at least four pins of the camera and the second arc slot rotatably supporting a fourth pin of the at least four pins of the camera,
wherein the first arm and the second arm are configured to rotate about a first axis allowing the camera to rotate about the first axis as well as about a second axis of the at least four pins.

2. The door apparatus according to claim 1, wherein the camera occupies a first orientation capturing a first view when the door is latched.

3. The door apparatus according to claim 1, wherein the camera occupies a second orientation capturing a second view when the first arm and the second arm rotates about the first axis.

4. The door apparatus according to claim 1, wherein the first open slot is formed at a first end along a length of the first arm.

5. The door apparatus according to claim 1, wherein the first arc slot is formed between a first end and a second end of the first arm in a substantially perpendicular manner to a length of the first arm.

6. The door apparatus according to claim 3, wherein the second pin of the camera slides in the first arc slot as the first arm rotates about the first axis.

7. The door apparatus according to claim 1, further comprising a camera bracket having a first profiled wall and a second profiled wall supporting the first pin and the third pin, respectively, and allowing a relative sliding motion between the camera bracket, and the first pin and the third pin.

8. The door apparatus according to claim 1, wherein the first arm and the second arm further include a first shaft and a second shaft, respectively, at a second end of the first arm and a second end of the second arm, respectively.

9. The door apparatus according to claim 8, wherein the first shaft and the second shaft have a D-shaped hollow cross-section at the second end of the first arm.

10. The door apparatus according to claim 9, further comprising:
a worm gear having a shaft portion and a worm portion; and
a gear lever having a gear portion and a handle portion,
wherein the gear lever is hinged at a hinge point located between the worm portion and the handle portion, and the gear portion is connected to the worm portion of the worm gear such that the first axis of rotation of the worm gear is perpendicular to a third axis of rotation of the gear lever.

11. The door apparatus according to claim 10, the shaft portion of the worm gear has a D-shaped cross-section that is inserted through the first shaft and the second shaft of the first arm and the second arm, respectively, providing a rotational input to the first arm and the second arm.

12. The door apparatus according to claim 10, the handle portion has an elongated profiled shape extending from a proximal end, at to the hinge point, to a distal end, away from the hinge point.

13. The door apparatus according to claim 12, further comprising:
a latch lever;
a latch having a striker slot and a pin slot hinged at a center to allow rotation about the third axis; and
a latch pin connecting the latch lever at one end and the latch at an opposite end, wherein the latch pin is inserted in the pin slot of the latch and provides a rotational input to the latch.

14. The door apparatus according to claim 13, wherein the latch pin is connected to an inner side of the handle portion of the gear lever and configured to slide from the distal end to the proximal end of the handle portion and vice-versa causing the gear lever to rotate about the third axis.

15. The door apparatus according to claim 13, further comprising a pawl connected to the latch along a circumference at the striker slot.

16. The door apparatus according to claim 1, wherein the first axis and the second axis are parallel to each other.

17. The door apparatus according to claim 10, wherein the first axis and the second axis are perpendicular to the third axis.

18. A door closing apparatus, comprising:
a camera configured to occupy a first orientation capturing a first view when a door is latched, and to occupy a second orientation capturing a second view when the door is unlatched;
a first arm supporting the camera on a first side; and
a second arm supporting the camera on a second side, wherein the first arm and the second arm are configured to rotate about a first axis allowing the camera to rotate about the first axis and about a second axis causing the camera to occupy a second orientation.

19. The door apparatus according to claim 18, wherein the camera includes a first pin and a second pin rotatably connected to the first arm.

20. The door apparatus according to claim 18, wherein the camera includes a third pin and a fourth pin rotatably connected to the second arm.
